(19) United States
(12) Patent Application Publication
(10) Pub. No.: US 2008/0225162 A1
(43) Pub. Date: Sep. 18, 2008

(54) Method and Apparatus for Deinterlaccing of Video Usung Motion Compensated Temporal Interpolation

(75) Inventor: Wilhelmus Hendrikus Alfonsus Bruls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,240

(22) PCT Filed: Jan. 3, 2005
(86) PCT No.: PCT/IB05/50010

§ 371 Date: Jul. 18, 2006

(30) Foreign Application Priority Data
Jan. 22, 2004 (EP) 04100196.7

(51) Int. Cl. H04N 7/01; G06K 9/32

(52) U.S. Cl. 348/448; 382/300; 348/E07.003

(57) ABSTRACT

A method and an apparatus for processing an interlaced video signal is disclosed. First, the interfaced video signal is de-interlaced. A plurality of temporal interpolated frames between original frames of the interlaced video signal are created using motion compensated temporal interpolation. The plurality of temporal interpolated frames and original frames are temporal filtered to produce an output video signal.

### FIELD OF THE INVENTION

The invention relates to a video encoder/decoder, and more particularly to a method and apparatus which can be used in low bitrate video compression applications.

### BACKGROUND OF THE INVENTION

The TV standards which have been used for many decades make use of so-called interlaced video signals. This method allows a reduction of the required bandwidth for transmission by a factor of 2, without comprising the picture quality in normal cases. For most moments during a sequence, still a relatively high resolution is offered (when the motion is not too great), yet for moments with a lot of motion, e.g., sporting events, the picture rate (50 or 60 Hz) is still relatively high enough in order to prevent annoying judder effects.

Because of the massive amounts of data inherent in digital video, the transmission of full-motion, high-definition digital video signals is a significant problem. More particularly, each digital image frame is a still image formed from an array of pixels according to the display resolution of a particular system. As a result, the amounts of raw digital information included in high-resolution video sequences are massive. In order to reduce the amount of data that must be sent, compression schemes are used to compress the data. Various video compression standards or processes have been established, including, MPEG-2, MPEG-4, and H.263.

Applying video compression using known compression techniques as MPEG-2 to video signals at the same pixel rate, compression is more efficient for progressive (non-interlaced, e.g. 720*480@30 Hz) signals as for interlaced signals (720*240*2@30 Hz or also known as 720*480i@60 Hz).

The DVD standard allows various formats which have different resolutions. The lower resolution formats are very useful for reducing the bitrate and therefore the recording time possible on a DVD disc. Most DVD formats are interlaced formats, at the full picture rate (50 or 60 Hz). The lowest resolution formats, also known as SIF or CIF (352*240 and 352*288) however, are only used as progressive format at reduced picture rates (25 or 30 Hz instead of 50 or 60 Hz), and are very suitable for long recording times because of the relative low bitrates needed for MPEG compression.

With respect to judder effects, judder effects are not a problem for pictures recorded with a celluloid camera, e.g. movies. The reason why pictures recoded with a celluloid camera show little judder effects is because of the shutter behavior of the camera. The long open time of the shutter causes a kind of smearing (temporal filtering) of fast moving objects due to the integration of photons on the celluloid. However, for pictures recorded with an interlace video camera with fast motion like sports, the judder effects are quite annoying. To enable recording times of 8 hours or more on a single DVD disc, the SIF formats can and will be used. However, the use of this format has the drawback of annoying judder effects for the recording of fast moving pictures. As a result, there is a need for a method for reducing the judder effects associated with fast moving pictures when SIF formats are used.

### SUMMARY OF THE INVENTION

The invention overcomes the deficiencies of other known schemes by electronically emulating the smearing of a celluloid camera prior to the use of low bitrate video compression applications.

According to one embodiment of the invention, a method and an apparatus for processing an interlaced video signal is disclosed. First, the interlaced video signal is de-interlaced. A plurality of temporal interpolated frames between original frames of the interlaced video signal are created using motion compensated temporal interpolation. The plurality of temporal interpolated frames and original frames are temporal filtered to produce an output video signal.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 is a block diagram of a temporal interpolation unit according to orie embodiment of the invention;

FIG. 2 illustrates the video stream at various stages of processing according to one embodiment of the invention; and

FIGS. 3(a)-b) illustrates various filter shapes which can be employed by the invention.

### DETAILED DESCRIPTION OF THE INVENTION

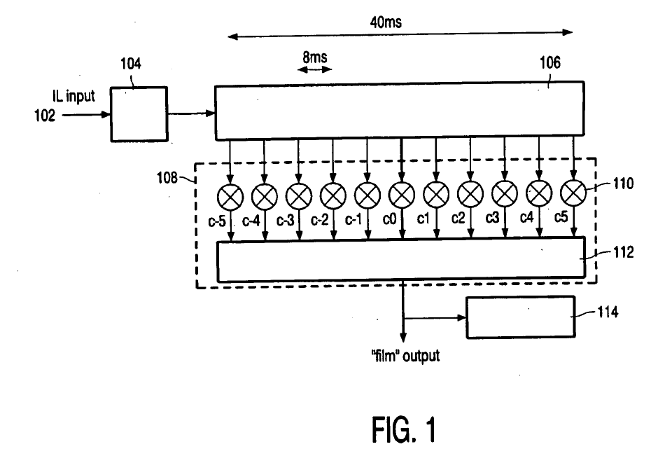

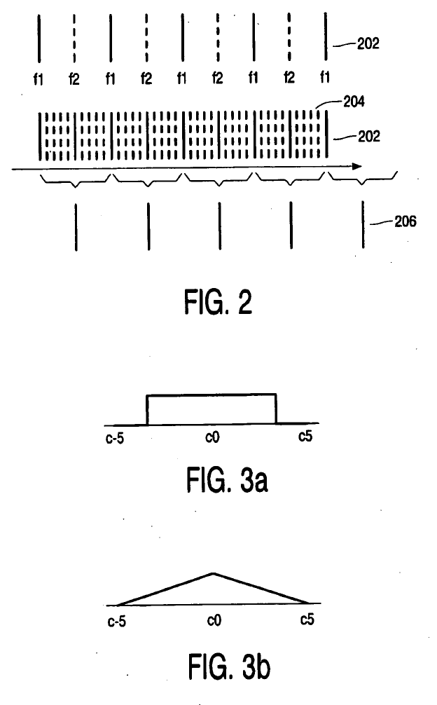

FIG. 1 illustrates a temporal interpolation unit 100 according to one embodiment of the invention. The temporal interpolation unit 100 will now be described with reference to FIGS. 1 and 2. An interlaced video input stream 102 is inputted into a de-interlacer 104. The de-interlacer 104 de-interlaces the input video stream and produces a de-interlaced video stream. The de-interlaced video stream is provided to a temporal interpolator 106. The temporal interpolator 106 creates a plurality of correctly temporal interpolated frames between each original frames of the normal interlaced video signal. The temporal interpolator 106 is performing motion estimation on the received frames. The calculated motion vectors can be scaled to any arbitrary position between two received frames, enabling motion compensation with these scaled vectors to construct a motion compensated frame on any arbitrary (desired) position in time. It will be understood by one skilled in the art that the temporal interpolator 106 may also use bi-directional motion estimation and compensation. Furthermore, the temporal interpolation may also use natural motion. A practical implementation is based on three-dimensional recursive search (3DRS) which is suitable for consumer applications, see for example the U.S. Pat. Nos. 5,072,293, 5,148,269, and 5,212,548.

As shown in FIG. 2, a large number of temporal interpolated frames 204 are created in between each original frame 202. The original frames 202 and the temporal interpolated frames 204 are then filtered by a temporal filter 108. The filtering over 2n+1 frames in order to construct one filtered frame (F) is performed by multiplying every given pixel (x,y) in frame i with its corresponding filter coefficient (i):

$${F}_{filt} ( x , y ) = {\sum }_{i = - n}^{i = + n} c ( i ) * F ( i ) ( x , y )$$

In this illustrative example, the filter 108 comprises a plurality of multiplication devices 110 which multiply the respective original and temporal interpolated frames by a coefficient (c-5, c-4, c-3, c-2, c-1, c0, c1, c2, c3, c4, and c5). In this illustrative example, the multiplication devices are spaced apart by 8 ms and the total distance between C-5 and c5 is 40 ms, but the invention is not limited thereto. The value of each coefficient is dependent on the shape of the filter being used. FIGS. 3(a)-(b) illustrate several filter shapes which can be used, but the invention is not limited thereto. The output values from the multipliers 110 are accumulated in an accumulator 112.

The accumulator 112 outputs a “celluloid” type signal 206 which can now be compressed into a very low bitrate making good use of the progressive SIF format, where the annoying judder effects are now largely avoided. As illustrated in FIG. 1, the signal 206 can be provided to an MPEG progressive encoder 114 for further processing.

It will be understood by those skilled in the art that the invention can also be applied for other types of formats, e.g., to convert full resolution 720*240*2@30 Hz interlace into 720*480@30 Hz progressive or for other application than DVD applications. It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

1. A method for processing a video signal, comprising the steps of:
creating a plurality of temporal interpolated frames between original frames of the video signal using temporal interpolation;
temporally filtering said plurality of temporal interpolated frames and original frames.

2. The method according to claim 1, further comprising the step of:
combining output of each temporal filter stage output into one filtered output frame per original frame.

3. The method according to claim 1, wherein the input signal is de-interlaced prior to the temporal interpolation.

4. The method according to claim 1, wherein the temporal interpolation uses motion estimation and motion compensation.

5. The method according to claim 1, wherein the temporal interpolation creates calculated motion vectors.

6. The method according to claim 4, wherein the calculated motion vectors are scaled according to desired time moment of the interpolated frame.

7. The method according to claim 1, wherein the temporal interpolation uses bi-directional motion estimation and compensation.

8. The method according to claim 1, wherein the temporal interpolation uses natural motion.

9. An apparatus for processing a video signal, comprising:
a temporal interpolation unit (106) for creating a plurality of temporal interpolated frames between original frames of the video signal using temporal interpolation;
a temporal filter unit (108) for temporal filtering said plurality of temporal interpolated frames and original frames;
an accumulator (112) for accumulating the outputs of the filter to produce an output video signal.

10. The apparatus according to claim 9, further comprising:
de-interlacing means (104) for de-interlacing the video signal.
